(19) United States
(12) Patent Application Publication
(10) Pub. No.: US 2011/0134883 A1
(43) Pub. Date: Jun. 9, 2011

(54) NETWORK BASED MOBILITY SYSTEM AND HANDOVER METHOD THEREOF

(75) Inventor: Saehoon KANG, Daejeon (KR)

(73) Assignee: Electronics and Telecommunications Research Institute, Daejeon (KR)

(21) Appl. No.: 12/946,840

(22) Filed: Nov. 15, 2010

(30) Foreign Application Priority Data
Dec. 9, 2009 (KR) 10-2009-0121969
Jun. 11, 2010 (KR) 10-2010-0055500

(51) Int. Cl. H04W 36/00

(52) U.S. Cl. 370/331

(57) ABSTRACT

A network-based mobility system and a handover method in the system are provided. If a mobile terminal having interfaces of different service providers establishes a connection between domains of the different service providers, a new domain to which the mobile terminal is connected sends a notification of the new connection to the existing domain to which the mobile terminal has been connected. If there is a flow binding switch operation caused by the new connection, the existing domain sends a flow binding setup request to the new domain. The new domain sets up flow binding for the mobile terminal. A tunnel for the corresponding flow is set up between the new domain and the existing domain, whereby packets transmitted to the existing domain are forwarded to the new domain through the tunnel.

### CROSS-REFERENCE TO RELATED APPLICATION

This application claims priority to and the benefit of Korean Patent Application Nos. 10-2009-0121969 and 10-2010-0055500 filed in the Korean Intellectual Property Office on Dec. 9, 2009 and Jun. 11, 2010, the entire contents of which are incorporated herein by reference.

### BACKGROUND OF THE INVENTION

(a) Field of the Invention

The present invention relates to a network-based mobility system and a handover method in the system. Particularly, the present invention relates to a network-based mobility system, which supports handover between domains of different service providers for a mobile terminal having interfaces of different service providers, and a handover method therein.

(b) Description of the Related Art

With the development of mobile communication technology, a mobile device, i.e., a mobile terminal, with multiple network interfaces mounted therein has emerged, and along with it, there is an increasing interest in means for efficiently using multiple interfaces simultaneously.

Selecting one of multiple interfaces of a mobile host and assigning it to a flow to be transmitted to a mobile terminal in such a mobile environment is termed “flow binding”. The flow binding involves binding a particular flow to a particular care of address (CoA). Here, a decision on which interface each flow should be assigned to is made by a policy associated with binding.

This flow binding method is closely associated with the mobility guarantee technology of the mobile terminal, and, like the existing mobility guarantee methods, can be largely divided into a terminal-based flow binding method and a network-based flow binding method.

First, in a conventional terminal-based flow binding method, the existing MIPv6 (mobile Internet protocol version 6) is extended to allow multiple CoAs to be registered in one home address. In accordance with this method, a mobile terminal that wish to bind flows creates a binding identification number (BID) for each flow binding, and sends a binding update with a binding identifier mobility option, and a home agent (HA) and a corresponding node (CN) create a binding cache entry based on this information and use it when sending a packet belonging to the corresponding flow.

This terminal-based method requires the mobile terminal to have a separate signaling protocol for communicating with a network mounted thereon, and has overhead of a complex process, such as message exchange for binding update, that the mobile terminal has to process.

On the other hand, in the existing network-based flow binding method, the network instead of the mobile terminal is responsible for message exchange associated with binding. Thus, the mobile terminal does not require a separate protocol stack, thus reducing the overhead of the mobile terminal. The current suggested network-based flow binding methods mainly use PMIPv6 (proxy mobile Internet protocol version 6), which is a network-based mobility management method. This PMIPv6 defines two functional elements, called mobile access gateway (hereinafter referred to as “MAG”) and local mobility anchor (hereinafter referred to as “LMA”).

The MAG functions to monitor the movement of a mobile terminal on an access link, and transmits the monitored information to the LMA in a proxy binding update (PBU) message. The LMA functions as the home agent for the mobile terminal in the PMIPv6 domain and, at the same time, manages information of the reachable state of the mobile terminal.

In this network-based flow binding method, when a mobile terminal is connected to the MAG belonging to a particular LMA domain, the LMA or the MAG determines flow binding based on a user profile or a service provider's policy.

The above-described network-based flow binding method relies on the assumption that all interfaces of a mobile terminal belong to one service provider, the mobile terminal has one home address, and MAGs to which the respective interfaces are connected are managed by one LMA.

However, in the case that interface devices mounted in a mobile terminal are respectively registered to different service providers in accordance with diversification of mobile communication services, the service providers will be assigned different home addresses, and MAGs to which the respective interfaces are connected belong to domains of different service providers, i.e., different LMA domains. Accordingly, with the above-described situation taken into account, there is a need for a network-based flow binding method that supports flow handover between domains of different service providers.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a mobility system, which, even if a mobile terminal has interfaces of different services providers, enables flow handover to a new interface because flow binding can be established between the domains of the different service providers without interruption from the mobile terminal, and a handover method in the system.

A handover method according to one aspect of the present invention,

which allows a mobile terminal having interfaces of different service providers to perform handover in switching flow binding from a first domain to which flows are bound to a second domain of a different service provider includes: receiving, by the first domain, notification of a new connection of the mobile terminal from the second domain; determining, by the first domain, whether to switch the binding of the flows of the mobile terminal bound to the first domain; if there is a flow requiring a binding switch operation, transmitting, by the first domain, a binding setup request for the flow to the second domain; and upon completion of the binding of the flow in response to the binding setup request, setting up, by the first domain, a tunnel with the second domain to complete handover for the flow.

A handover method according to another aspect of the present invention,

which allows a mobile terminal having interfaces of different service providers to perform handover in switching a flow binding from a first domain to which flows are bound to a second domain of a different service provider includes: recognizing, by the second domain, a new connection of the mobile terminal; notifying, by the second domain, the first domain of the new connection of the mobile terminal; receiving, by the second domain, a flow binding setup request for the mobile terminal from the first domain; setting up, by the second domain, flow binding for the mobile terminal in response to the request; and setting up, by the second domain, a tunnel with the first domain to complete handover.

A mobility system according to still another aspect of the present invention,

which is a network-based mobility system supporting flow handover between domains of different service providers, includes: a mobile access gateway that monitors movement of a mobile terminal on an access link, and, upon receipt of a notification of a new connection of the mobile terminal from a foreign domain when the mobile terminal having interfaces of different service providers is connected, sending a flow binding setup request for the mobile terminal; a local mobility anchor that acts as a home agent for the mobile terminal within a domain via the mobile access gateway, receives the notification of the new connection of the mobile terminal from the foreign domain to forward the notification to the mobile access gateway, and forwards the flow binding setup request to the foreign domain; and an attachment exchange server that is located in the domain of each of the different service providers, acts as a node for exchanging information between the different service providers, receives the notification of the new connection of the mobile terminal from the foreign domain to forward the notification to the local mobility anchor, and receives the flow binding setup request from the local mobility anchor to forward the same to the foreign domain, wherein, upon completion of the flow binding setup in the foreign domain, the local mobility anchor sets up a tunnel with a local mobility anchor of the foreign domain.

A mobility system according to yet another aspect of the present invention,

which is a network-based mobility system supporting flow handover between domains of different service providers, includes: a mobile access gateway that monitors movement of a mobile terminal on an access link, and, when the mobile terminal having interfaces of different service providers establishes a new connection, sends a notification of the new connection; a local mobility anchor that acts as a home agent for the mobile terminal within a domain via the mobile access gateway, forwards the notification of the new connection to the foreign domain upon receipt of the notification of the new connection of the mobile terminal from the mobile access gateway, and forwards a flow binding setup request for the mobile terminal sent from the foreign domain to the mobile access gateway; and an attachment exchange server that is located in the domain of each of the different service providers, acts as a node for exchanging information between the different service providers, receives the notification of the new connection of the mobile terminal from the local mobility anchor to forward the notification to the foreign domain, and receives the flow binding setup request for the mobile terminal from the foreign domain to forward the same to the local mobility anchor, wherein, upon completion of the flow binding setup in the mobile access gateway, the local mobility anchor sets up a tunnel with a local mobility anchor of the foreign domain.

### BRIEF DESCRIPTION OF THE DRAWINGS

FIG. 1 is a view schematically showing a general network-based mobility system.

FIG. 2 is a view showing an initial connection procedure of a mobile terminal in a general network-based mobility system.

FIG. 3 is a view schematically showing a network-based mobility system according to an exemplary embodiment of the present invention.

FIG. 4 is a flowchart of a flow handover method between domains of different service providers according to an exemplary embodiment of the present invention.

FIG. 5 is a view showing a packet transfer process after handover of flows between domains of different service providers according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation, and can be implemented by hardware components or software components and combinations thereof.

In this specification, a mobile terminal (MT) may refer to a terminal, a mobile station (MS), a subscriber station (SS), a portable subscriber station (PSS), user equipment (UE), or an access terminal (AT). The mobile terminal may include all or part of the functions of the mobile station, the subscriber station, the portable subscriber station, and the user equipment.

Now, a network-based mobility system that supports flow handover between domains of different service providers and a handover method in the system according to an exemplary embodiment of the present invention will be described in detail with reference to the drawings.

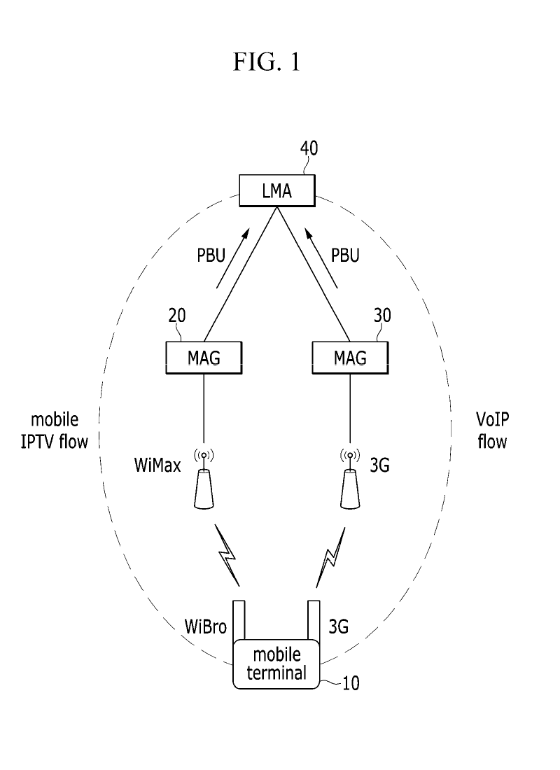

FIG. 1 is a view schematically showing a general network-based mobility system.

As shown in FIG. 1, when a mobile terminal 10 (hereinafter, the mobile terminal refers to a mobile terminal having multiple interfaces mounted therein) communicates with a correspondent terminal (not shown) in order to connect to various access networks, it may be connected to an LMA 40 over different wireless links (WiMax, 3G) provided by MAGs 20 and 30. The multiple interfaces mounted in the mobile terminal 10 all belong to one service provider. Therefore, the mobile terminal 10 can use both Internet protocol television (IPTV) flow and voice over Internet protocol (VOIP) flow via two interfaces on one LMA domain.

As noted above, in order for the mobile terminal 10 to connect to the MAGs 20 and 30 and receive a communication service through the LMA 40, the mobile terminal 10 has to be connected to the LMA 40 via the MAGs 20 and 30 in accordance with an initial connection procedure based on PMIPv6.

This initial connection procedure is as follows. Here, a description will be made under the assumption that the mobile terminal 10 is connected through the MAG 20.

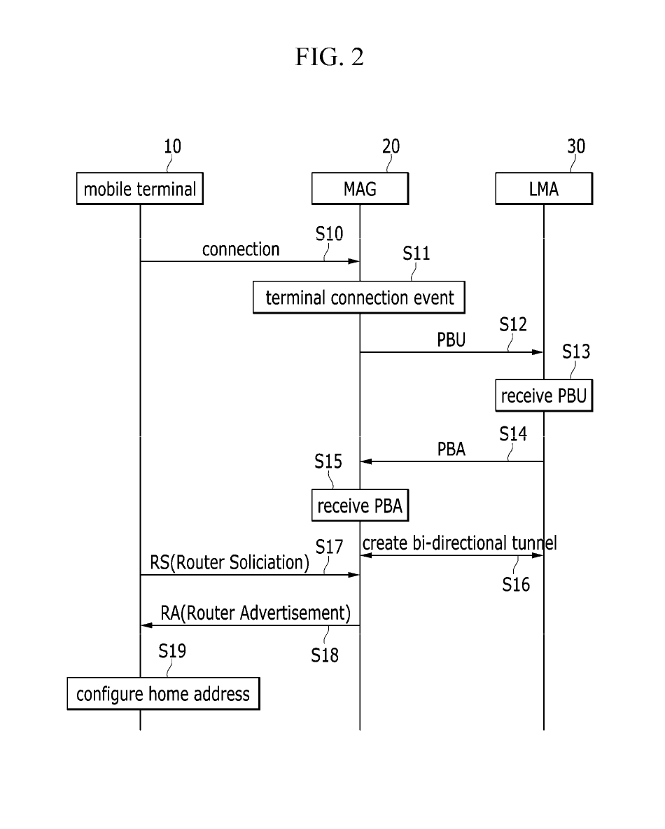

Referring to FIG. 2, when the mobile terminal 10 moves and enters the coverage of the MAG 20 and is connected to the MAG 20 (S10), a terminal connection event occurs in the MAG 20 and the MAG 20 acquires the identifier and profile of the mobile terminal 10 (S11). After that, the MAG 20 sends a proxy binding update (PBU) message to the LMA 40 (S12).

The LMA 40 receives the PBU message from the MAG 20 and allocates a home network prefix (HNP) to the mobile terminal 10, and sets up a binding cache entry (BCE) for the mobile terminal 10 (S13). After that, in response to the PBU message, the LMA 40 sends a PBA message to the MAG 20 (S14). At this time, the PBA message includes the HNP for the mobile terminal 10.

After receiving the PBA message, the MAG 20 sets up a bi-directional tunnel with the LMA 40 (S16).

After that, the mobile terminal 10 sends a router solicitation (RS) message to the MAG 20 (S17), and, in response to this message, the MAG 20 sends a router advertisement (RA) message to the mobile terminal 10 (S18). At this time, the HNP for the mobile terminal 10 is included in the RA message and transmitted to the mobile terminal 10.

The mobile terminal 10 creates an MN home address (MN-HoA) by using the HNP included in the RA message, and performs communication within the PMIPv6 domain by using the MN-HoA.

Alternatively, the mobile terminal 10 may be connected to the LMA 40 through the MAG 30. At this point, an MN-HoA can be created as well by the above initial connection procedure.

Under the above network-based mobility system, however, the multiple interfaces mounted in the mobile terminal 10 all belong to one service provider. Thus, the MN-HoA created when the mobile terminal 10 is connected through the MAGs 20 and 30 is the same, so that only one home address is given. With one home address given, flow binding depending on the movement between the MAGs 20 and 30 of the mobile terminal 10 or environmental changes can be performed under the control of the LMA 40.

However, in the case that the multiple interfaces mounted in the mobile terminal 10 are respectively registered to different service providers, different home addresses created through the respective interfaces are assigned to the respective service providers, and MAGs corresponding to the respective interfaces also belong to different LMAs. Thus, at this point, flow binding depending on the movement between the MAGs or environmental changes cannot be performed.

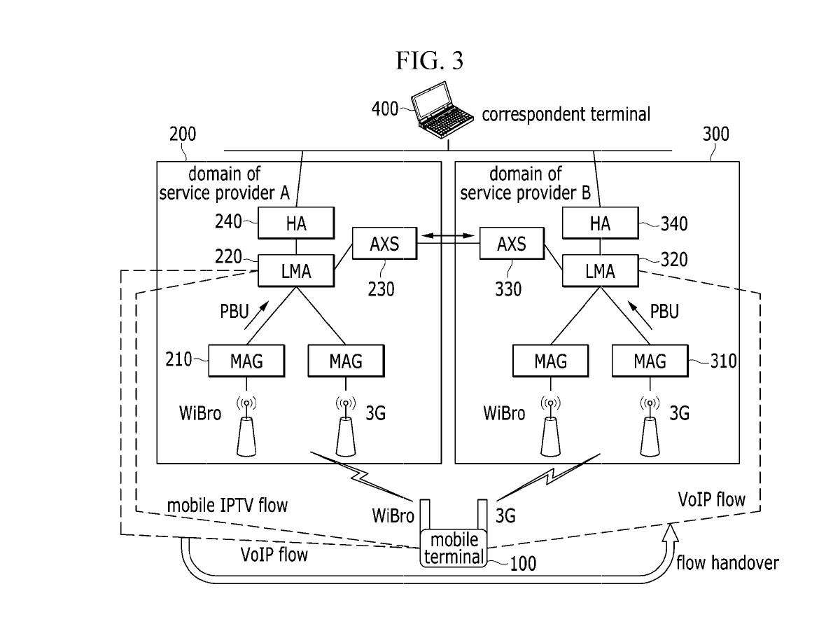

FIG. 3 is a view schematically showing a network-based mobility system according to an exemplary embodiment of the present invention for solving the above-described problem.

As shown in FIG. 3, the network-based mobility system according to the exemplary embodiment of the present invention provides a mobile communication service with a correspondent node, that is, a correspondent terminal 400 to a mobile terminal 100 having multiple interfaces mounted therein and registered to different service providers through domains 200 and 300 of the different service providers. Here, the domain 200 is a domain of service provider A, and the domain 300 is a domain of service provider B. A description will be made under the assumption that the service providers of the two domains 200 and 300 are different from each other and that both of the domains 200 and 300 are capable of providing a WiBro service and a 3G service.

The mobile terminal 100 has two interfaces mounted therein, which are accessible to WiBro and 3G. A description will be made under the assumption that the WiBro interface is an interface registered to service provider A and the 3G interface is an interface registered to service provider B. That is, in order for the mobile terminal 100 to connect to a WiBro network using the WiBro interface, it has to connect to the WiBro network of the domain 200 of service provider A, while in order for the mobile terminal 100 to connect to a 3G network using the 3G interface, it has to connect to the 3G network of the domain 300 of service provider B. Herein, the description is made under the assumption that the mobile terminal 100 has two interfaces mounted therein, but the technical scope of the present invention is not limited thereto and the mobile terminal 100 may have three or more interfaces mounted therein or may have interfaces registered to three or more service providers mounted therein.

The domains 200 and 300 of the network-based mobility system according to the exemplary embodiment of the present invention include MAGs 210 and 310, LMAs 220 and 320, attachment exchange servers (hereinafter referred to as “AXSs”) 230 and 330, and HAs 240 and 340. The MAG 210, LMA 220, AXS 230, and HA 240 included in the domain 200 and the MAG 310, LMA 320, AXS 330, and HA 340 included in the domain 300 perform the same functions, so the components included only in the domain 200 will be described herein.

The MAG 210 functions to monitor the movement of the mobile terminal 100 on an access link and transmit the monitored information to the LMA 200 in a PBU message.

In the exemplary embodiment of the present invention, when the MAG 210 receives, from the LMA 220, new connection information indicating that the mobile terminal 100 connected to the MAG 210 has established a new connection through a foreign domain, e.g., the domain 300, the MAG 210 determines whether to switch the existing flow binding set up for the mobile terminal 100. At this point, the MAG 210 determines whether to switch the flow binding based on a user profile or policy stored for the mobile terminal 100. Then, if it is determined that the flow binding for the mobile terminal 100 needs to be switched, the MAG 210 sends a new flow binding setup request to the LMA 220.

Moreover, upon reception of the new flow binding setup request from the LMA 220, the MAG 210 sets up a flow binding for the mobile terminal 100 in response to the new flow binding request. In the present exemplary embodiment, this operation is performed in the MAG 310.

The LMA 220 acts as a home agent for the mobile terminal 100 within the domain 200. Moreover, the LMA 220 is an anchor point in the topology of HNP assigned to the mobile terminal 100, and functions to manage the reachability state of the mobile terminal 100 within the domain 200.

In the exemplary embodiment of the present invention, when the LMA 220 receives, from the AXS 230, new connection information indicating that the mobile terminal 100 connected to the LMA 220 has established a new connection through a foreign domain, e.g., the domain 300, the LMA 220 forwards this information to the MAG 210. Also, if there is a new flow binding setup request from the MAG 210, it is forwarded to the AXS 230.

Moreover, if there is a new connection via an interface of the mobile terminal 100, the LMA 220 notifies the AXS 230 of the new connection. Also, if a new flow binding setup request for the mobile terminal 100 that has been already connected to another domain, e.g., the domain 300, is received through the AXS 230, the LNA 220 forwards it to the MAG 210.

If new flow binding is set up between the domains 200 and 300, the LMA 220 sets up a tunnel for the corresponding flow with the LMA 300 of another domain, e.g., the domain 300.

The AXSs 230 and 330 are nodes for exchanging information between service providers. An AXS exists separately in each service provider domain 200, and may be used for the purpose of exchange of connection information of the mobile terminal for each service provider domain. The AXS may be cooperatively managed by service providers who have signed an interconnection agreement, or may be independently managed by a third service provider (e.g., a mobile virtual network operator (MVNO) service provider) that has signed an agreement with each service provider.

In an exemplary embodiment using this AXS, AXSs belonging to, for example, service provider A and service provider B exchange connection information of the mobile terminal 100 connected to the respective domains 200 and 300, and respectively forward this information to the LMA 200. The AXS 230 identifies each mobile terminal 100 by using an MN-Identifier, which is the identifier of the mobile terminal 100 defined in PMIPv6, and manages the network connection status of each mobile terminal 100.

In the exemplary embodiment of the present invention, upon receipt of new connection information indicating that the mobile terminal 100 connected to the domain 200 to which the AXS 230 belongs has established a new connection through a foreign domain, e.g., the domain 300, from the AXS 330 of the corresponding domain 300, the AXS 230 forwards this information to the LMA 220. Also, if there is a new flow binding setup request from the LMA 220, it is forwarded to the AXS 330 of the corresponding domain 300.

Moreover, when the AXS 230 receives a notification of the new connection through an interface of the mobile terminal 100 from the LMA 220, the AXS 230 notifies the AXS 330 of the other domain 300 of the new connection together with the identifier of the mobile terminal 100. Also, when a new flow binding setup request for the mobile terminal 100 that has been already connected to the other domain 300 is received from the AXS 330 of the domain 300, the AXS 230 forwards it to the LMA 220.

The HA 240 acts as a home agent for the mobile terminal 100, and functions to relay communication with the correspondent terminal 400.

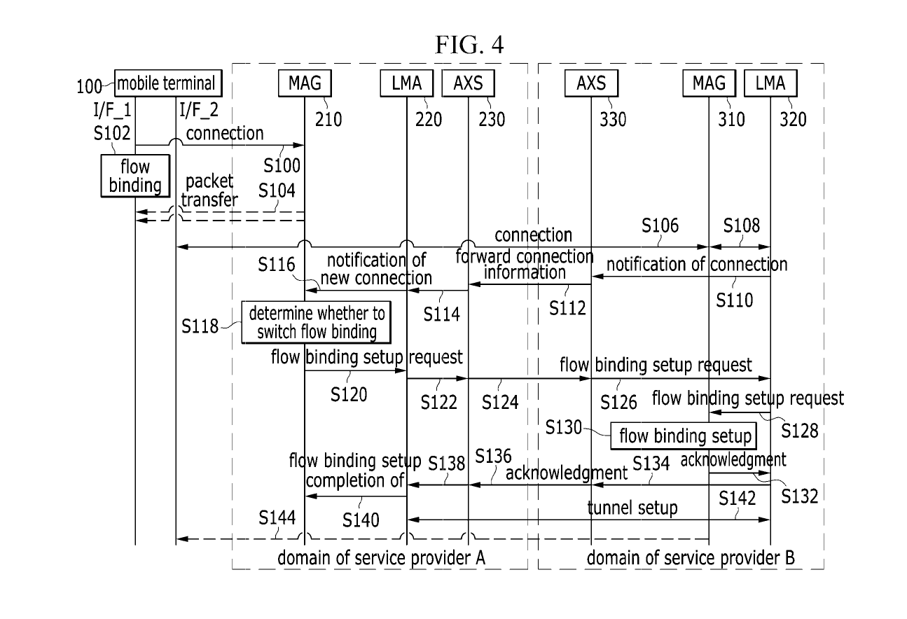

Referring to FIG. 4, a flow handover method between domains of different service providers according to an exemplary embodiment of the present invention will be described below.

First, as explained with reference to FIG. 3, a mobile terminal 100 is registered to service provider A, is registered, along with a WiBro network accessible interface (I/F_1), to service provider B, and has a 3G network accessible interface (I/F_2) mounted therein.

In the exemplary embodiment of the present invention, a description will be made assuming that, as a new connection is established to the 3G network of the domain 300 through the 3G interface (I/F_2) while the mobile terminal 100 is receiving a service of a VoIP flow and a mobile IPTV flow by connecting to the domain 200 via the WiBro interface (I/F_1), handover is performed by switching the binding of the VoIP flow serviced through the WiBro interface (I/F_1) to the 3G interface (I/F2). However, one skilled in the art will understand that the exemplary embodiment of the present invention may be implemented in more various configurations than the above-mentioned case.

Moreover, it is assumed that service provider A and service provider B are service providers that have signed an interconnection agreement.

First, the mobile terminal 100 moves into the area of the MAG 210 within the domain 200 and is connected to the network of service provider A through the WiBro interface (I/F_1). That is, the WiBro interface (I/F_1) of the mobile terminal 100 is connected to the LMA 220 through the MAG 210 of the domain 200 in accordance with the initial connection procedure described with reference to FIG. 2 (S100).

Although the mobile terminal 100 wants to operate two applications, e.g., a VOIP application and a mobile IPTV application, an interface usable by the mobile terminal 100 is the WiBro interface (I/F_1) alone. Thus, the flow bindings for the VoIP application and the mobile IPTV application are performed. That is, flows the VoIP application and the mobile IPTV application are allocated to the WiBro interface (I/F_1) (S102).

When the flow bindings for the VoIP application and the mobile IPTV application are established, packets sent to and received from the correspondent terminal 400 for the VoIP application and the mobile IPTV application are forwarded through the MAG 210 (S104).

As such, when the mobile terminal 100 is connected to the MAG 210 within the domain 200 of service provider A through the WiBro interface (I/F_1) registered to service provider A and operates the VoIP application and the mobile IPTV application with the correspondent terminal 400 through the LMA 220 and the HA 240, the mobile terminal 100 is connected to the domain 300 of service provider B through the 3G interface (I/F_2) registered to service provider B due to changes in mobile or communication environments (S106 and S108). Here, the mobile terminal 100 is connected to the LMA 320 through the MAG 310 of the domain 300 by using the 3G interface (I/F_2) in accordance with the initial connection procedure described with reference to FIG. 2.

Accordingly, the LMA 320 of the domain 300 recognizes that the mobile terminal 100 has established a new connection through the 3G interface (I/F_2), and notifies the AXS 330 of the new connection of the mobile terminal 100, i.e., network connection information (S110). At this point, the LMA 320 notifies the AXS 330 by using the MN-Identifier defined as the identifier of the mobile terminal 100 in PMIPv6. Moreover, if there is a connection to the LMA 320, it is obvious that the LMA 320 should determine whether this connection is a new connection to its domain 300. Thus, a detailed description thereof will be omitted.

The AXS 330 forwards the notification of the new connection of the mobile terminal 100 received from the LMA 320 to AXSs belonging to different service providers with which the interconnection agreement was signed. In the exemplary embodiment of the present invention, the AXS 330 forwards the notification of the new connection of the mobile terminal 100 to the AXS 230 within the domain 200 of service provider A with which the interconnection agreement was signed (S112).

After that, since the AXS 230 having received the notification of the new connection of the mobile terminal 100 from the AXS 330 is aware that the mobile terminal 100 has already been connected to its domain 200, the AXS 230 notifies the LMA 220 of the new connection, i.e., new network connection information, and the LMA 220 forwards this to the MAG 210 to which the mobile terminal 100 is connected (S114 and S116). Here, it is obvious that the AXS 230, having received the notification of the new connection of the mobile terminal 100 from the AXS 330, should determine whether the mobile terminal 100 has been already connected to its domain 200. Thus, a detailed description thereof will be omitted.

Meanwhile, when the MAG 210 within the domain 200 receives a notification through the LMA 220 that the mobile terminal 100 connected to the MAG 210 has established a new connection to a new domain 300 of a different service provider, the MAG 210 determines whether the existing flow binding set up for the mobile terminal 100 needs to be switched based on a user profile or policy associated with flow binding stored in the MAG 210 or stored corresponding to the mobile terminal 100 (S118). That is, it is determined whether flow bindings for the VoIP application and the mobile IPTV application are currently set up for the mobile terminal 100 through the WiBro interface (I/F_1), and if it is desirable to set up these flow bindings through the 3G interface (I/F_2) newly connected to the domain 300.

In the exemplary embodiment of the present invention, a description will be made assuming that the user profile or policy associated with flow binding defines that the VoIP application is preferably serviced through the 3G network rather than through the WiBro network.

Accordingly, the MAG 210 determines that the flow binding for the VoIP application through the WiBro interface (I/F_1) for the mobile terminal 100 needs to be switched to flow binding through the 3G interface (I/F_2) that has established a new connection to the domain 300 in the step S118 in accordance with the user profile or policy associated with flow binding.

In accordance with this determination, the MAG 210 transmits, to the LMA 220, a new flow binding setup request for the VoIP application of the mobile terminal 100 in a PBU message (S120).

The LMA 220 forwards the new flow binding setup request from the MAG 210 to the AXS 230, the AXS 230 forwards it to the AXS 330 of the domain 300, and the AXS 330 forwards it to the LMA 320 (S122, S124, and S126).

Upon acceptance of the request for the flow binding setup through the newly connected 3G interface (I/F_2) for the mobile terminal 100 whose new connection is recognized in the step S110, the LMA 320 makes a request for flow binding setup for the VoIP application of the mobile terminal 100 to the MAG 310 to which the mobile terminal 100 has established a new connection (S128).

In response to the flow binding setup request from the LMA 320, the MAG 310 sets up flow binding for the VoIP application in the mobile terminal 100 to the 3G interface (I/F_2) (S130), and then transmits a message indicative of the acknowledgment of a new flow binding setup to the LMA 320 (S312).

The LMA 320 forwards a notification of the acceptance of the new flow binding setup request from the MAG 310 to the LMA 220 of the domain 200 through the AXS 330 and the AXS 230 (S134, S136, and S138).

Next, the LMA 220 transmits a PBU message to the MAG 210 to notify the MAG 210 of completion of the new flow binding setup requested in the step S120 (S140).

When the flow binding setup for the VoIP application is switched by a new connection of the mobile terminal 100 between the domain 200 and the domain 300, the LMA 220 and the LMA 320 set up a tunnel T1 for the corresponding flow, i.e., flow for the VoIP application therebetween (S142).

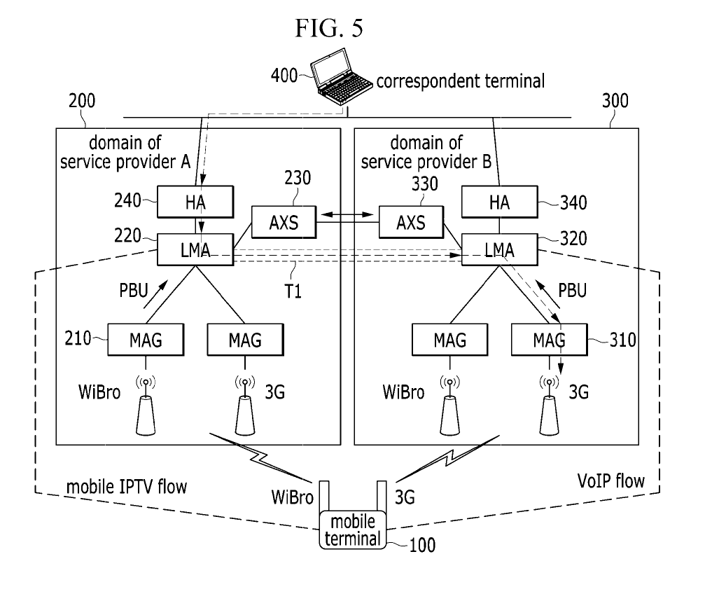

When a tunnel is set up between the LMA 220 and the LMA 320, as shown in FIG. 5, if packets with an address assigned by the existing service provider A for the VoIP application to be sent to the mobile terminal 100 arrive at the LMA 220 through the HA 240, the LMA 220 forwards these packets to the LMA 320 through the setup tunnel T1, and the LMA 320 forwards these packets to the 3G interface (I/F_2) of the mobile terminal 100 through the MAG 310 (S144).

As seen from the above, even if the mobile terminal 100 has separate interfaces belonging to different service providers, flow binding can be switched on a network basis without interruption from the mobile terminal 100, and the switching of the flow binding enables flow handover between domains belonging to different service providers.

Although the above description has been made assuming that the MAG 210 makes a determination about the switching of flow binding based on a user profile or policy associated with flow binding, the present invention is not limited thereto, and the LMA 220 stores information of the user profile or policy associated with flow binding and therefore is able to perform the above-described process according to determination about the switching of flow binding. In this case, a notification of a new connection of the mobile terminal 100 to a new domain 300 is forwarded no further than the LMA 220 in the domain 200 and does not need to be forwarded to the MAG 210, and a flow binding setup request for a flow binding switch operation is created from the LMA 220 and transmitted to the domain 300.

According to the present invention even if a mobile terminal has interfaces of different service providers, flow binding can be established between the domains of the different service providers without interruption from the mobile terminal.

Furthermore, even if a mobile terminal having interfaces of different service providers is connected to a foreign domain through a new interface, handover of flows between the domains is enabled.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A handover method, which allows a mobile terminal having interfaces of different service providers to perform handover in switching flow binding from a first domain to which flows are bound to a second domain of a different service provider, comprising:
receiving, by the first domain, notification of a new connection of the mobile terminal from the second domain;
determining, by the first domain, whether to switch the binding of the flows of the mobile terminal bound to the first domain;
if there is a flow requiring a binding switch operation, transmitting, by the first domain, a binding setup request for the flow to the second domain; and
upon completion of the binding of the flow in response to the binding setup request, setting up, by the first domain, a tunnel with the second domain to complete handover for the flow.

2. The handover method of claim 1, wherein the receiving of a notification comprises:
an attachment exchange server of the first domain receiving a notification of a new connection of the mobile terminal from the second domain;
the attachment exchange server determining whether the mobile terminal is connected to the first domain;
if the mobile terminal is connected to the first domain, the attachment exchange server forwarding the notification of the new connection to a local mobility anchor of the first domain; and
the local mobility anchor forwarding the notification of the new connection to a mobile access gateway to which the mobile terminal is connected.

3. The handover method of claim 2, wherein, in the determining whether to switch the binding, the mobile access gateway determines whether to switch the flow binding set up for the mobile terminal based on a user profile or a policy associated with flow binding.

4. The handover method of claim 3, wherein, if there is flow requiring a binding switch operation, the mobile access gateway transmits a binding setup request for the corresponding flow to the second domain through the local mobility anchor and the attachment exchange server.

5. The handover method of claim 1, wherein the new connection indicates that the mobile terminal is connected to the second domain through an interface registered to a different service provider other than the service provider to which the interface connected to the first domain is registered.

6. A handover method, which allows a mobile terminal having interfaces of different service providers to perform handover in switching flow binding from a first domain to which flows are bound to a second domain of a different service provider, including:
recognizing, by the second domain, a new connection of the mobile terminal;
notifying, by the second domain, the first domain of the new connection of the mobile terminal;
receiving, by the second domain, a flow binding setup request for the mobile terminal from the first domain;
setting up, by the second domain, flow binding for the mobile terminal in response to the request; and
setting up, by the second domain, a tunnel with the first domain to complete handover.

7. The handover method of claim 6, wherein, in the recognizing, if there is a connection of the mobile terminal via a mobile access gateway of the second domain and the mobile terminal is connected to the second domain for the first time, a local mobility anchor of the second domain recognizes this connection as a new connection.

8. The handover method of claim 7, wherein, in the notifying, an attachment exchange server of the second domain receives a notification of the new connection of the mobile terminal from the local mobility anchor and notifies the second domain of the new connection.

9. The handover method of claim 8, wherein
in the receiving, the attachment exchange server receives a flow binding setup request for the mobile terminal from the first domain and forwards the request to the mobile access gateway through the local mobility anchor, and
in the setting up of flow binding, the mobile access gateway performs the flow binding setup requested by the first domain.

10. The handover method of claim 6, wherein the new connection indicates that the mobile terminal is connected to the second domain through an interface registered to a different service provider other than the service provider to which the interface connected to the first domain is registered.

11. A mobility system, which is a network-based mobility system supporting flow handover between domains of different service providers, the mobility system comprising:
a mobile access gateway that monitors movement of a mobile terminal on an access link, and, upon receipt of a notification of a new connection of the mobile terminal from a foreign domain when the mobile terminal having interfaces of different service providers is connected, sending a flow binding setup request for the mobile terminal;
a local mobility anchor that acts as a home agent for the mobile terminal within a domain via the mobile access gateway, receives the notification of the new connection of the mobile terminal from the foreign domain to forward the notification to the mobile access gateway, and forwards the flow binding setup request to the foreign domain; and
an attachment exchange server that is located in each of the domains of the different service providers, acts as a node for exchanging information between the different service providers, receives the notification of the new connection of the mobile terminal from the foreign domain to forward the notification to the local mobility anchor, and receives the flow binding setup request from the local mobility anchor to forward the same to the foreign domain,
wherein, upon completion of the flow binding setup in the foreign domain, the local mobility anchor sets up a tunnel with a local mobility anchor of the foreign domain.

12. The mobility system of claim 11, wherein, upon receipt of the notification of the new connection of the mobile terminal from the foreign domain, the mobile access gateway determines whether the flow binding set up for the mobile terminal needs to be switched, and if there is a flow requiring a binding switch operation, transmits a flow binding setup request for the corresponding flow to the local mobility anchor.

13. The mobility system of claim 12, wherein the mobile access gateway determines whether to switch the flow binding set up for the mobile terminal based on a user profile or a policy associated with flow binding.

14. A mobility system, which is a network-based mobility system supporting flow handover between domains of different service providers, the mobility system comprising:
a mobile access gateway that monitors movement of a mobile terminal on an access link, and, when the mobile terminal having interfaces of different service providers establishes a new connection, sends a notification of the new connection;
a local mobility anchor that acts as a home agent for the mobile terminal within a domain via the mobile access gateway forwards the notification of the new connection to the foreign domain upon receipt of the notification of the new connection of the mobile terminal from the mobile access gateway, and forwards a flow binding setup request for the mobile terminal sent from the foreign domain to the mobile access gateway; and
an attachment exchange server that is located in the domain of each of the different service providers, acts as a node for exchanging information between the different service providers, receives the notification of the new connection of the mobile terminal from the local mobility anchor to forward the notification to the foreign domain, and receives the flow binding setup request for the mobile terminal from the foreign domain to forward the same to the local mobility anchor,
wherein, upon completion of the flow binding setup in the mobile access gateway, the local mobility anchor sets up a tunnel with a local mobility anchor of the foreign domain.

15. The mobility system of claim 14, wherein, if the mobile terminal is connected to the mobile access gateway through an interface registered to a different service provider other than the service provider to which the interface connected to the foreign domain is registered.
